(19) United States
(12) Patent Application Publication
(10) Pub. No.: US 2009/0153630 A1
(43) Pub. Date: Jun. 18, 2009

(54) LIQUID SUPPLY DEVICE AND LIQUID EJECTING APPARATUS

(75) Inventors: Hiroyuki ITO, Matsumoto-shi (JP); Hideya YOKOUCHI, Okaya-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/337,307

(22) Filed: Dec. 17, 2008

(30) Foreign Application Priority Data
Dec. 18, 2007 (JP) 2007-326240
Sep. 1, 2008 (JP) 2008-224155
Nov. 28, 2008 (JP) 2008-305013

(51) Int. Cl. B41J 2/175

(52) U.S. Cl. 347/85

(57) ABSTRACT

A liquid supply device includes a liquid supply path for supplying liquid from an upstream side toward a downstream side where the liquid is consumed. A negative pressure chamber communicates with a decompression chamber through a communication hole and decompresses the decompression chamber. A communication hole valve body opens and closes the communication hole. A biasing member biases the valve body in a direction in which the valve body is always in a closed state. A flexible member forms a part of a wall surface of the negative pressure chamber and is displaced by a change in pressure within the negative pressure chamber. A communication hole valve body pressure member is displaced by the displacement of the flexible member to thereby press the valve body in a direction in which the valve body is in an open state against a biasing force of the biasing member.

The entire disclosure of Japanese Patent Application No. 2007-329240, filed Dec. 18, 2007 and Japanese Patent Application No. 2008-224155, filed Sep. 1, 2008 and Japanese Patent Application No. 2008-305013, filed Nov. 28, 2008 are expressly incorporated herein by reference.

### BACKGROUND

1. Technical Field

The present invention relates to a liquid ejecting apparatus, such as an ink jet printer, and a liquid supply device provided in the liquid ejecting apparatus.

2. Related Art

In general, an ink jet printer (hereinafter, simply referred to as a ‘printer’) is widely known as an example of a liquid ejecting apparatus that ejects ink (liquid) from a nozzle of a recording head (liquid ejecting head) onto a target. In such a printer, poor printing, such as dot missing, may be caused when a bubble is generated in the ink ejected from the recording head. For this reason, a printer capable of making gas dissolved in ink escape (removed) from the ink in order to suppress such poor printing has been proposed in the related art (for example, refer to JP-A-2006-95878).

In the printer disclosed in JP-A-2006-95878, a part of a side wall that forms a common liquid chamber (defoaming chamber) of a printing head (liquid supply device) is formed of a gas permeable film (partition wall), and a chamber (decompression chamber) that is decompressed by a pump is provided on an opposite side of the common liquid chamber with the gas permeable film interposed therebetween. In addition, since a pressure difference between the common liquid chamber and the chamber occurs when the chamber is decompressed by the pump, the gas dissolved in ink within the common liquid chamber permeates through the gas permeable film to escape into the chamber due to the pressure difference.

However, in the printer disclosed in JP-A-2006-95878, a decompressed state in the chamber is not maintained if the pump is stopped. Accordingly, the pump should be driven all the time in order to maintain the inside of the chamber in the decompressed state.

### SUMMARY

An advantage of some aspects of the invention is that it provides a liquid supply device and a liquid ejecting apparatus capable of maintaining a decompressed state in a decompression chamber even if a pump is stopped after decompressing the inside of the decompression chamber with the pump.

According to an aspect of the invention, a liquid supply device includes: a liquid supply path used to supply liquid from an upstream side, which is a liquid supply source side, toward a downstream side at which the liquid is consumed; a defoaming chamber that is provided in the middle of the liquid supply path and holds a bubble contained in the liquid in order to make the bubble escape from the liquid; a decompression chamber that is provided at a position adjacent to the defoaming chamber with a partition wall interposed therebetween and is decompressed by a pump to have lower pressure than the defoaming chamber, the partition wall being configured to allow gas to permeate therethrough by decompression of the decompression chamber and to regulate permeation of liquid; a negative pressure chamber that communicates with the decompression chamber through a communication hole and has negative pressure to decompress the decompression chamber; a communication hole valve body that makes the communication hole closed when the communication hole valve body is in a closed state and makes the communication hole open when the communication hole valve body is in an open state; a communication hole valve body biasing member that biases the communication hole valve body in a direction in which the communication hole valve body is always in a closed state; a flexible member for negative pressure chamber that forms a part of a wall surface of the negative pressure chamber and is displaced on the basis of a change in pressure within the negative pressure chamber; and a communication hole valve body pressure member that is displaced by the displacement of the flexible member for negative pressure chamber to thereby press the communication hole valve body in a direction in which the communication hole valve body is in an open state against a biasing force of the communication hole valve body biasing member.

According to such a configuration, since the negative pressure occurs in the negative pressure chamber when suction in the negative pressure chamber is performed by a pump, the flexible member for negative pressure chamber is displaced by the negative pressure. Since the displacement of the flexible member for negative pressure chamber causes the communication hole valve body pressure member to press the communication hole valve body in the direction in which the communication hole valve body is in an open state, the communication hole is opened such that the negative pressure chamber and the decompression chamber communicate with each other through the communication hole. As a result, since suction in the decompression chamber is performed together with the negative pressure chamber by the pump, the decompression chamber becomes in a decompressed state. In addition, when the pump is stopped after the decompression chamber became in the decompressed state, the negative pressure of the negative pressure chamber is removed and the flexible member for negative chamber returns to the original position. Then, since the communication hole valve body biasing member biases the communication hole valve body in the direction in which the communication hole valve body is closed, the communication hole is closed such that the negative pressure chamber and the decompression chamber do not communicate with each other. As a result, the decompressed state of the decompression chamber is maintained. Therefore, it becomes possible to maintain the decompression chamber in the decompressed state even if the pump is stopped after decompressing the decompression chamber with the pump.

According to another aspect of the invention, a liquid supply device includes: a liquid supply path used to supply liquid from an upstream side, which is a liquid supply source side, toward a downstream side at which the liquid is consumed; a defoaming chamber that is provided in the middle of the liquid supply path and is able to make a bubble contained in the liquid escape from the liquid; a decompression chamber that is provided at a position adjacent to the defoaming chamber with a partitioning portion interposed therebetween and is decompressed by a pump to have lower pressure than the defoaming chamber, the partitioning portion being configured to allow gas to permeate therethrough by decompression of the decompression chamber and to regulate permeation of liquid; a negative pressure chamber that communicates with the decompression chamber through a communication hole and has negative pressure to decompress the decompression chamber; a communication hole valve body that makes the communication hole closed when the communication hole valve body is in a closed state and makes the communication hole open when the communication hole valve body is in an open state; a communication hole valve body biasing member that biases the communication hole valve body in a direction in which the communication hole valve body is in a closed state; a flexible member for negative pressure chamber that forms a part of a wall surface of the negative pressure chamber and is displaced on the basis of a change in pressure within the negative pressure chamber; and a communication hole valve body pressure member that is displaced by the displacement of the flexible member for negative pressure chamber to thereby press the communication hole valve body in a direction in which the communication hole valve body is in an open state against a biasing force of the communication hole valve body biasing member.

According to such a configuration, since the negative pressure occurs in the negative pressure chamber when suction in the negative pressure chamber is performed by a pump, the flexible member for negative pressure chamber is displaced by the negative pressure. Since the displacement of the flexible member for negative pressure chamber causes the communication hole valve body pressure member to press the communication hole valve body in the direction in which the communication hole valve body is in an open state, the communication hole is opened so that the negative pressure chamber and the decompression chamber communicate with each other through the communication hole. As a result, since suction in the decompression chamber is performed together with the negative pressure chamber by the pump, the decompression chamber becomes in a decompressed state. In addition, when the pump is stopped after the decompression chamber became in the decompressed state, the negative pressure of the negative pressure chamber is removed and the flexible member for negative chamber returns to the original position. Then, since the communication hole valve body biasing member biases the communication hole valve body in the direction in which the communication hole valve body is closed, the communication hole is closed such that the negative pressure chamber and the decompression chamber do not communicate with each other. As a result, the decompression state of the decompression chamber is maintained. Therefore, it becomes possible to maintain the decompression chamber in the decompressed state even if the pump is stopped after decompressing the decompression chamber with the pump.

In the liquid supply device according to the aspect of the invention, it is preferable that a pressure chamber that has an inflow hole for inflow of the liquid and a discharge hole for discharge of the liquid, an inflow hole valve body that makes the inflow hole closed when the inflow hole valve body is in a closed state and makes the inflow hole open when the inflow hole valve body is in an open state, an inflow hole valve body biasing member that biases the inflow hole valve body in a direction in which the inflow hole valve body is always in a closed state, a flexible member for pressure chamber that forms a part of a wall surface of the pressure chamber and is displaced on the basis of a change in pressure within the pressure chamber, and an inflow hole valve body pressure member that is displaced by the displacement of the flexible member for pressure chamber to thereby press the inflow hole valve body in a direction in which the inflow hole valve body is in an open state against a biasing force of the inflow hole valve body biasing member be further included, the pressure chamber and the negative pressure chamber be provided in parallel, and the flexible member for negative pressure chamber and the flexible member for pressure chamber be integrally formed.

According to such a configuration, when the amount of liquid in the pressure chamber decreases as the liquid is consumed at the downstream side, the negative pressure occurs in the pressure chamber. Then, the flexible member for pressure chamber is displaced by the negative pressure. Since the displacement of the flexible member for pressure chamber causes the inflow hole valve body pressure member to press the inflow hole valve body in the direction in which the inflow hole valve body is in an open state, the inflow hole is opened such that the liquid is supplied from the upstream side into the pressure chamber, and the negative pressure within the pressure chamber is removed. Then, since the flexible member for pressure chamber returns to the original position, the inflow hole valve body biasing member biases the inflow hole valve body in the direction in which the inflow hole valve body is in a closed state. As a result, the inflow hole is closed to stop the supply of the liquid into the pressure chamber. Therefore, since the negative pressure chamber is provided in parallel with the pressure chamber that forms a part of the liquid supply path and the flexible member for negative pressure chamber and the flexible member for pressure chamber are integrally formed, it becomes possible to reduce the number of components and to make the device small compared with a case where the flexible member for negative pressure chamber and the flexible member for pressure chamber are formed of separate members.

In the liquid supply device according to the aspect of the invention, it is preferable that the communication hole valve body pressure member and the inflow hole valve body pressure member be integrally formed.

According to such a configuration, it becomes possible to reduce the number of components compared with a case where the communication hole valve body pressure member and the inflow hole valve body pressure member are formed of separate members.

In the liquid supply device according to the aspect of the invention, it is preferable that a negative chamber forming member that forms the negative chamber, a decompression chamber forming member that forms the decompression chamber, and a partition wall that forms a partitioning portion interposed between the defoaming chamber and the decompression chamber be bonded to each other by adhesives in a state where the negative chamber forming member, the decompression chamber forming member, and the partition wall are piled, and the adhesives be covered not to be exposed to the outside.

According to such a configuration, since the adhesive is not exposed to the outside, the adhesive is not influenced by the external environment. As a result, since deterioration of the adhesive can be suppressed, a decrease in adhesive strength of the adhesive can be suppressed. In addition, by covering the adhesive with a member not allowing liquid to permeate therethrough, evaporation of the liquid to the outside can be suppressed without being influenced by the liquid permeability of the adhesive.

According to still another aspect of the invention, a liquid ejecting apparatus includes: a liquid ejecting head that ejects liquid; and the liquid supply device that supplies the liquid to the liquid ejecting head and has the configuration described above. According to such a configuration, the same operations and effects as described above can be obtained.

### BRIEF DESCRIPTION OF THE DRAWINGS

The invention will be described with reference to the accompanying drawings, wherein like numbers reference like elements.

FIG. 1 is a plan view schematically illustrating a printer according to an embodiment.

FIG. 2 is a planar sectional view illustrating a valve unit in the printer.

FIG. 3 is a cross-sectional view taken along the line III-III of FIG. 2.

FIG. 4 is a cross-sectional view taken along the line IV-IV of FIG. 2.

FIG. 5 is a cross-sectional view taken along the line V-V of FIG. 3.

FIG. 6 is an enlarged view illustrating an air communicating path of the valve unit in the printer.

### DESCRIPTION OF EXEMPLARY EMBODIMENTS

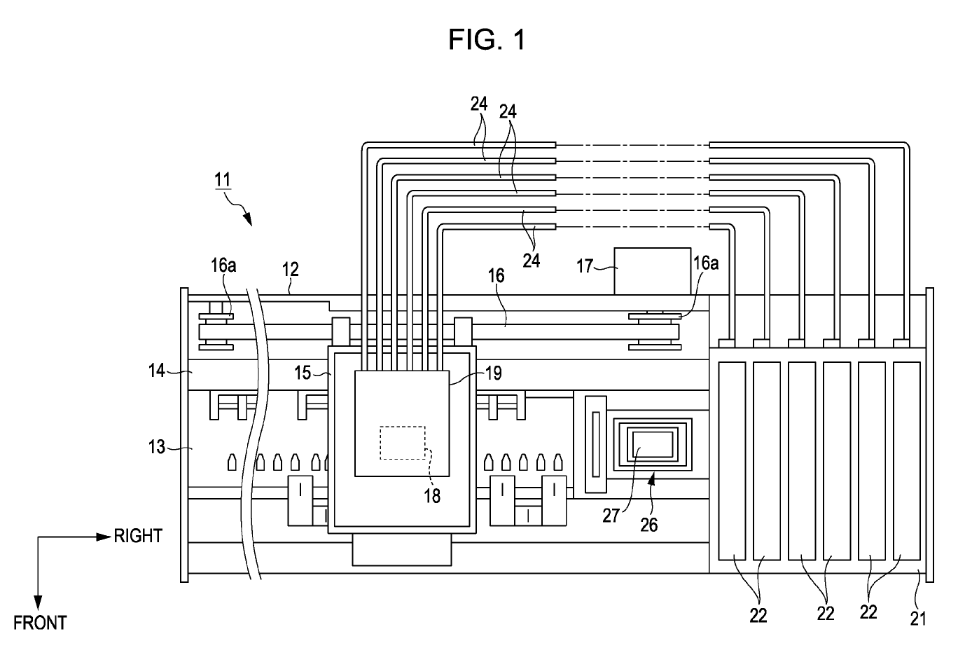

Hereinafter, an ink jet printer which is an example of a liquid ejecting apparatus according to an embodiment of the invention will be described with reference to the accompanying drawings. Moreover, in the following description, ‘back and forth direction’, ‘left and right direction’, and ‘up and down direction’ refer to back and forth direction, left and right direction, and up and down direction indicated by arrows shown in FIG. 1.

As shown in FIG. 1, an ink jet printer 11 as a liquid ejecting apparatus includes a body flame 12 having a rectangular shape in plan view. In the body flame 12, a platen 13 is provided to extend in the left and right direction which is a main scanning direction. On the platen 13, recording paper (not shown) is fed along the back and forth direction, which is a sub-scanning direction, by a paper feed mechanism (not shown). In addition, a rod-like guide shaft 14 extending in parallel in the longitudinal direction (left and right direction) of the platen 13 is provided above the platen 13 in the body flame 12.

A carriage 15 is supported on the guide shaft 14 such that the carriage 15 can reciprocate along the guide shaft 14. The carriage 15 is connected with a carriage motor 17, which is provided on a back surface of the body flame 12, through an endless timing belt 16 stretched between a pair of pulleys 16a provided on an inner surface of a rear wall of the body flame 12. Accordingly, the carriage 15 reciprocates along the guide shaft 14 by driving of the carriage motor 17.

As shown in FIG. 1, a recording head 18 as a liquid ejecting head is supported on a lower end side of the carriage 15 facing the platen 13. In addition, a valve unit 19 that supplies ink as liquid, which is temporarily stored, to a downstream side (side of the recording head 18) and has a rectangular shape in plan view is mounted on the carriage 15.

A plurality of nozzles (not shown) is opened in a bottom surface of the recording head 18. Printing is performed by ejecting an ink droplet from an opening of each nozzle onto recording paper (not shown) fed on the platen 13 by driving a piezoelectric element (not shown) provided in the recording head 18.

A cartridge holder 21 is provided in a right end portion of the body flame 12. In the cartridge holder 21, a plurality of ink cartridges 22 (six ink cartridges 22 in the present embodiment) that contain different kinds (colors) of ink therein are detachably mounted. In addition, the ink cartridges 22 are located at the most upstream side as liquid supply sources. The cartridge holder 21 is connected with the valve unit 19, which is mounted on the carriage 15, through a plurality of ink supply tubes 24 (six ink supply tubes 24 in the present embodiment).

Moreover, in a state where each ink cartridge 22 is mounted in the cartridge holder 21, each ink cartridge 22 communicates with the valve unit 19 through each ink supply tube 24. In addition, the valve unit 19 stores ink, which is supplied from each ink cartridge 22 through each ink supply tube 24, temporarily and separately. The ink that is stored temporarily and separately is supplied to the recording head 18.

Furthermore, as shown in FIG. 1, a maintenance unit 26 for performing the maintenance, such as cleaning, of the recording head 18 is provided in a home position region of the carriage 15 positioned near the right end portion in the body flame 12. The maintenance unit 26 includes: a cap 27 that comes in contact with the recording head 18 to surround each nozzle (not shown) of the recording head 18 or receives ink discharged from the opening of each nozzle by flushing; and a suction pump (not shown) that can performs suction in the cap 27.

In addition, by performing suction in the cap 27 with a suction pump (not shown) in a state where the cap 27 is made to come in contact with the recording head 18 to surround the opening of each nozzle (not shown) of the recording head 18, a bubble or ink whose viscosity has increased is forcibly discharged from each nozzle (not shown) into the cap 27, so-called cleaning is performed.

Next, the configuration of the valve unit 19 will be described in detail.

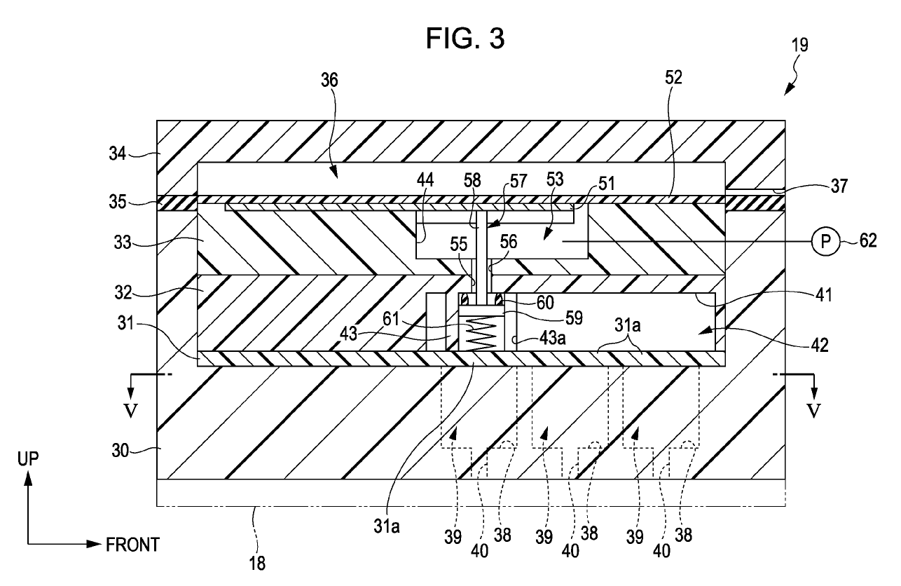

As shown in FIG. 3, the valve unit 19 includes a defoaming chamber forming member 30 having a square box shape with a bottom, a plate-shaped partition wall 31 provided on an inner bottom surface of the defoaming chamber forming member 30, a plate-shaped decompression chamber forming member 32 provided on an upper surface of the partition wall 31, and a plate-shaped negative pressure chamber forming member 33 provided on an upper surface of the decompression chamber forming member 32. On the upper surface of the defoaming chamber forming member 30, a cover member 34 having a roofed square box shape is fixed by a screw (not shown) with sealing rubber 35 interposed therebetween such that an upper end opening of the defoaming chamber forming member 30 is blocked.

An inner bottom surface of the defoaming chamber forming member 30 and a bottom surface of the partition wall 31 are bonded to each other with an adhesive, an upper surface of the partition wall 31 and a bottom surface of the decompression chamber forming member 32 are bonded to each other with an adhesive, and an upper surface of the decompression chamber forming member 32 and a bottom surface of the negative pressure chamber forming member 33 are bonded to each other with an adhesive. Accordingly, the partition wall 31, the decompression chamber forming member 32, and the negative pressure chamber forming member 33 are completely covered with the defoaming chamber forming member 30 and the cover member 34. In addition, the defoaming chamber forming member 30, the partition wall 31, the decompression chamber forming member 32, the negative pressure chamber forming member 33, and the cover member 34 are formed of a synthetic resin that has rigidity and does not allow liquid to permeate therethrough.

A space is formed between the negative pressure chamber forming member 33 and the cover member 34, and the space serves as an air chamber 36. An air communicating path 37 that makes the air chamber 36 communicate with the atmosphere is formed between the sealing rubber 35 and a bottom surface in a front end portion of the cover member 34. Accordingly, the air chamber 36 is always maintained in an atmospheric pressure. The air communicating path 37 extends in a long and meandering shape as shown in FIG. 6. In addition, the air communicating path 37 serves to make the air chamber 36 communicate with the atmosphere and to prevent the moisture from evaporating from the air chamber 36 to the atmosphere.

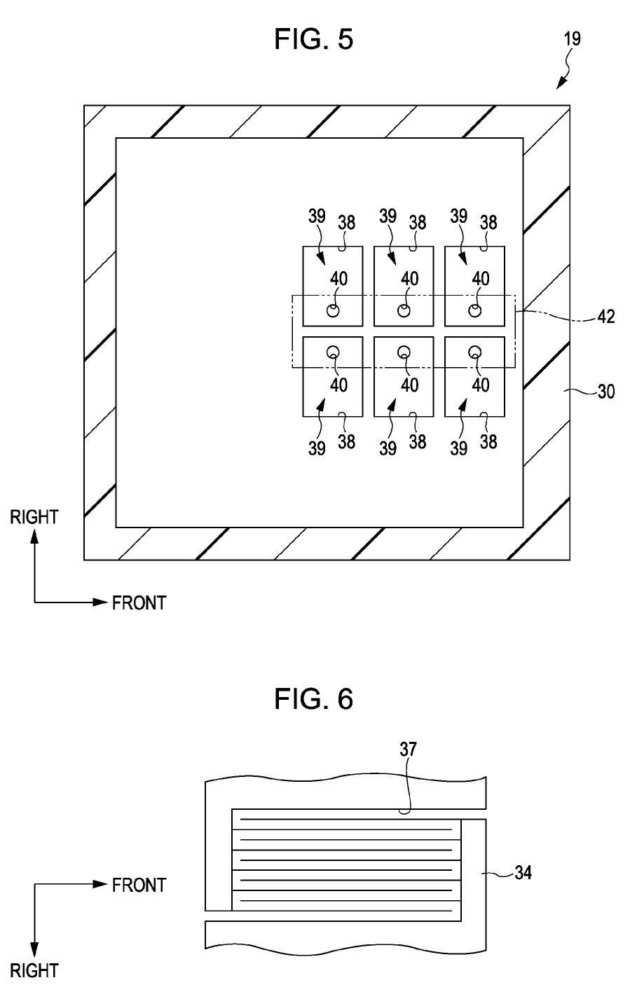

As shown in FIG. 5, a plurality of defoaming recesses 38 (six defoaming recesses 38 in the present embodiment) having rectangular shapes in plan view extending in the horizontal direction are provided in parallel at front-end-side positions of the inner bottom surface of the defoaming chamber forming member 30. The defoaming recesses 38 are disposed at equal distances in the back and forth direction and left and right direction to form three columns in the back and forth direction and two columns in the back and forth direction. That is, the six defoaming recesses 38 are disposed such that the left three defoaming recesses 38 and the right three defoaming recesses 38 are symmetrical with respect to the middle of the defoaming chamber forming member 30 in the left and right direction.

As shown in FIGS. 3 and 5, six spaces formed to be surrounded by the defoaming recesses 38 and the partition wall 31 serve as defoaming chambers 39 for holding a bubble contained (floating) in ink entering from the upstream side in order to make the bubble escape from the ink. Moreover, an outlet 40 for making the ink within the defoaming chamber 39 flow to the side of the recording head 18 positioned at the downstream side, in which the ink is consumed, is opened in a portion, which is an end portion on a middle portion side in the left and right direction of the defoaming chamber forming member 30 and is a middle portion in the back and forth direction, on a bottom surface of each defoaming recess 38.

As shown in FIG. 3, a decompression recess 41 having a rectangular shape in plan view extending in the front and rear direction is formed on a front end side of a bottom surface of the decompression chamber forming member 32, and a space formed to be surrounded by the decompression recess 41 and the partition wall 31 serves as a decompression chamber 42. The decompression chamber 42 is decompressed so that the internal pressure of the decompression chamber 42 is lower than the pressure of each defoaming chamber 39. In addition, the decompression chamber 42 partially overlaps the defoaming chamber 39 on the side of the outlet 40 in plan view, as shown in FIG. 5. That is, the decompression chamber 42 overlaps the outlet 40 of each defoaming chamber 39 in the up and down direction (vertical direction).

In addition, the partition wall 31 is molded by using a material allowing gas to permeate therethrough when the decompression chamber 42 is decompressed, for example, POM (polyacetal), PP (polypropylene), or PPE (polyphenylene ether).

In addition, a portion of the partition wall 31 interposed between the decompression chamber 42 and each defoaming chamber 39 serves as a partitioning portion 31a, and the decompression chamber 42 is disposed above the defoaming chamber 39 so as to be positioned adjacent to the defoaming chamber 39 with the partitioning portion 31a of the partition wall 31 interposed therebetween. In addition, the thickness of the partition wall 31 (partitioning portion 31a) is set to allow a bubble in each defoaming chamber 39 to permeate through the partition wall 31 by decompression of the decompression chamber 42. In this case, the gas permeability of a synthetic resin used to form the partition wall 31 is set to be higher than that of a synthetic resin used to form the defoaming chamber forming member 30, the decompression chamber forming member 32, the negative pressure chamber forming member 33, and the cover member 34. Accordingly, the partitioning portion 31a can serve to increase the gas permeability compared with a portion having a thickness other than the partitioning portion 31a.

Moreover, in the present embodiment, it could be seen from the experimental result that the appropriate permeation efficiency was obtained when the area and thickness of the partitioning portion 31a were set to about 1 cm² and 1 mm, respectively. In addition, it is also preferable to use a material having an air permeation coefficient of 5 cc·mm/m²·day·atm or more and a moisture permeation coefficient of 30 g·mm/m²·day·atm or less. A material, which satisfies this condition, other than the materials described above, may also be used to form the partition wall 31.

A cylindrical case portion 43 extending up and down is formed on an upper surface of a rear end portion in the decompression chamber 42, and a bottom surface of the case portion 43 is in contact with the upper surface of the partition wall 31. A slit 43a that makes the inside and outside of the case portion 43 communicate with each other is formed on a front end side of the case portion 43. Accordingly, the inside of the case portion 43 communicates with the inside of the decompression chamber 42. In addition, a negative pressure recess 44 is formed on an upper surface of the negative pressure chamber forming member 33 so as to overlap the case portion 43 of the decompression chamber forming member 32 in the up and down direction.

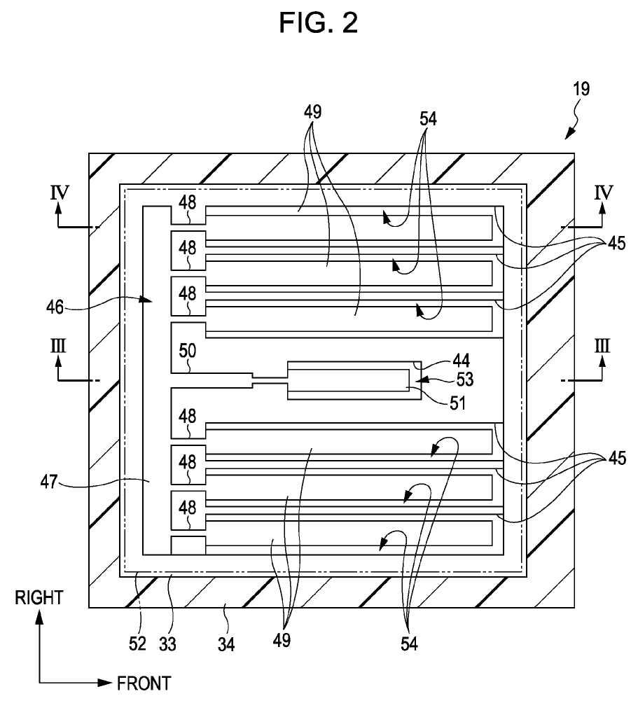

As shown in FIG. 2, the negative pressure recess 44 is located in the middle of the upper surface of the negative pressure chamber forming member 33 and has a rectangular shape in plan view extending in the front and rear direction. In addition, a plurality of pressure recesses 45 (six pressure recesses 45 in the present embodiment) are formed on the upper surface of the negative pressure chamber forming member 33. Each pressure recess 45 has a rectangular shape in plan view extending in the front and rear direction.

In addition, the length of each pressure recess 45 in the front and rear direction is larger than that of the negative pressure recess 44, and the width of each pressure recess 45 in the left and right direction is equal to that of the negative pressure recess 44. In addition, the six pressure recesses 45 are disposed at equal distances such that the left three pressure recesses 45 and the right three pressure recesses 45, which are positioned at left and right sides with respect to the negative pressure recess 44, are parallel. That is, the longitudinal direction of the negative pressure recess 44 and the longitudinal direction of each pressure recess 45 are the same as the front and rear direction, and the negative pressure recess 44 and each pressure recess 45 are provided to be parallel in the left and right direction.

In addition, an operation plate 46 formed by one thin plate made of stainless steel with appropriate elasticity is disposed on the upper surface of the negative pressure chamber forming member 33. The operation plate 46 includes a base portion 47 that is positioned in a rear end portion of the upper surface of the negative pressure chamber forming member 33 and has a rectangular shape in plan view extending in the left and right direction. The base portion 47 is fixed on the upper surface of the negative pressure chamber forming member 33, and a pressure connecting portion 48 extending in the front direction toward each pressure recess 45 is provided on a front end portion of the base portion 47 opposite a rear end portion of each pressure recess 45.

Each pressure connecting portion 48 extends up to the rear end portion of each pressure recess 45 in plan view, and a pressure operating portion 49 serving as an inflow hole valve body pressure member that has a rectangular shape and is slightly smaller than the pressure recess 45 in plan view is provided at the front end of each pressure connecting portion 48. That is, each pressure operating portion 49 overlaps each corresponding pressure recess 45 such that each pressure operating portion 49 is included within each corresponding pressure recess 45 in plan view. In addition, edges of each pressure operating portion 49 on both ends thereof in the left and right direction are bent downward at a right angle, and the width of each pressure operating portion 49 in the left and right direction is larger than that of each pressure connecting portion 48.

A negative pressure connecting portion 50 extending in the front direction toward the negative pressure recess 44 is provided on a front end portion of the base portion 47 opposite a rear end portion of the negative pressure recess 44. The width of a front end portion of the negative pressure connecting portion 50 in the left and right direction is smaller than that of a base end portion of the negative pressure connecting portion 50 in the left and right direction, and the width of the front end portion in the left and right direction is the same as that of each pressure connecting portion 48. A negative pressure operating portion 51 serving as a communication hole valve body pressure member, which has a rectangular shape and is slightly smaller than the negative pressure recess 44 in plan view, is provided on a front end of the front end portion of the negative pressure connecting portion 50.

That is, the negative pressure operating portion 51 overlaps the negative pressure recess 44 such that the negative pressure operating portion 51 is included within the negative pressure recess 44 in plan view. In addition, edges of the negative pressure operating portion 51 on both ends thereof in the left and right direction are bent downward at a right angle. In addition, since the working pressure of each pressure operating portion 49 is larger than that of the negative pressure operating portion 51, the length of each pressure operating portion 49 in the front and rear direction is larger than that of the negative pressure operating portion 51. In addition, a front end of each pressure operating portion 49 and a front end of the negative pressure operating portion 51 are free ends that are not fixed.

In addition, a film member 52 formed of a sheet of flexible synthetic resin, which serves as a flexible member for negative pressure chamber and a flexible member for pressure chamber, is welded on the upper surface of the negative pressure chamber forming member 33 so as to cover the entire upper surface of the negative pressure chamber forming member 33 from above the operation plate 46. The film member 52 seals an upper end opening of the negative pressure recess 44 and an upper end opening of each pressure recess 45 individually. A space surrounded by the film member 52 and the negative pressure recess 44 serves as a negative pressure chamber 53, and a space surrounded by the film member 52 and each pressure recess 45 serves as a pressure chamber 54. Accordingly, the negative pressure chamber 53 and each pressure chamber 54 do not communicate with each other.

As shown in FIG. 3, on an upper wall within the case portion 43 of the decompression chamber forming member 32, a first communication hole 55 serving as a communication hole passing through the upper wall up and down is formed. On a bottom wall of the negative pressure chamber 53 of the negative pressure chamber forming member 33, a second communication hole 56 serving as a communication hole passing through the bottom wall up and down is formed corresponding to the first communication hole 55. That is, the first communication hole 55 and the second communication hole 56 have the same internal diameter and communicate with each other. Accordingly, the negative pressure chamber 53 and the case portion 43 communicate with each other through the first communication hole 55 and the second communication hole 56.

In the decompression chamber 42 and the negative pressure chamber 53, a negative pressure valve body 57 serving as a communication hole valve body is accommodated to be stretched between the chambers 42 and 53. The negative pressure valve body 57 includes a cylindrical negative pressure valve shaft 58 inserted between the first communication hole 55 and the second communication hole 56 and a disc-shaped negative pressure flange 59 which is provided in a lower end portion of the negative pressure valve shaft 58 in the case portion 43 and has a larger external diameter than the negative pressure valve shaft 58. A lower end of the negative pressure valve shaft 58 is connected with the center of an upper surface of the negative pressure flange 59, and an upper end of the negative pressure valve shaft 58 is in contact with a bottom surface of the negative pressure operating portion 51.

The external diameter of the negative pressure flange 59 is larger than the internal diameters of the first and second communication holes 55 and 56 and is slightly smaller than the internal diameter of the case portion 43. On the upper surface of the negative pressure flange 59, an annular negative pressure sealing member 60 formed of a flexible material is fixed along a peripheral edge of the upper surface such that the negative pressure valve shaft 58 is surrounded. The external diameter of the negative pressure sealing member 60 is almost the same as the external diameter of the negative pressure flange 59. In addition, a negative pressure coiled spring 61 serving as a communication hole valve body biasing member is interposed between a bottom surface of the negative pressure flange 59 and the upper surface of the partition wall 31 within the case portion 43.

The negative pressure coiled spring 61 biases the negative pressure valve body 57 upward such that the negative pressure valve body 57 is always in a closed state. Furthermore, in a state where the negative pressure valve body 57 is closed, the negative pressure sealing member 60 comes in contact with an upper wall surface within the case portion 43 in a state surrounding the first communication hole 55 to thereby make the first communication hole 55 closed. That is, the case portion 43 and the negative pressure chamber 53 do not communicate with each other. In addition, the negative pressure chamber 53 may be decompressed by a decompression pump 62 as a pump.

In addition, the negative pressure valve body 57 is disposed between the decompression pump 62 and the decompression chamber 42. Accordingly, even if the decompression pump 62 is not always driven, it is possible to maintain the decompression chamber 42 in a decompressed pressure state for a long time. As a result, even in a case where a power supply of the ink jet printer 11 is turned off, it is also possible to perform defoamed from the decompression chamber 42.

In addition, when the negative pressure chamber 53 is decompressed by the decompression pump 62 and the negative pressure occurs in the negative pressure chamber 53, the film member 52 is displaced to bend toward the negative pressure chamber 53 (downward) due to a difference between the negative pressure and the atmospheric pressure. By displacement of the film member 52, the negative pressure operating portion 51 elastically deforms to cause a rear end of the negative pressure operating portion 51 to bend downward as a hinge.

Due to the elastic deformation of the negative pressure operating portion 51, the negative pressure valve shaft 58 is pressed downward against the biasing force of the negative pressure coiled spring 61 by the negative pressure operating portion 51 and the negative pressure sealing member 60 is spaced apart from the upper wall surface within the case portion 43. As a result, the negative pressure valve body 57 is opened. In addition, when the negative pressure valve body 57 is in an open state, the first communication hole 55 is in an open state, that is, the case portion 43 and the negative pressure chamber 53 communicate with each other.

Furthermore, in the present embodiment, the load of the negative pressure coiled spring 61, the area of the negative pressure operating portion 51 or negative pressure chamber 53, and the like are set such that the negative pressure valve body 57 is in an open state when the pressure within the negative pressure chamber 53 is −30 kPa or more and the negative pressure valve body 57 is in a closed state when the pressure within the negative pressure chamber 53 is less than −30 kPa.

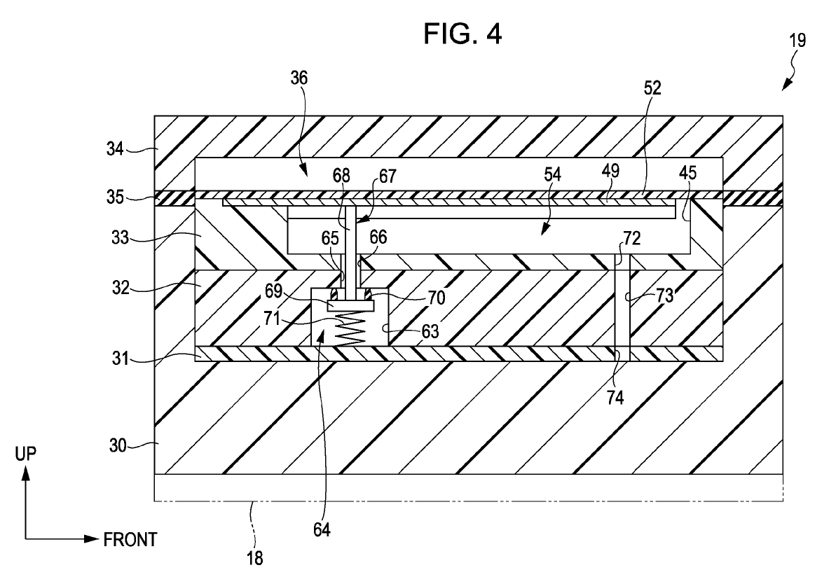

As shown in FIG. 4, an ink supply recess 63 is formed on the bottom surface of the decompression chamber forming member 32 so as to overlap the rear end portion of each pressure recess 45 in the up and down direction, and a space surrounded by each ink supply recess 63 and the partition wall serves as an ink supply chamber 64. In each ink supply chamber 64, a downstream end of an inflow channel (not shown) whose upstream end is connected to a downstream end of each ink supply tube 24 (refer to FIG. 1) is opened.

On an upper wall of each ink supply chamber 64 in the decompression chamber forming member 32, a first inflow hole 65 serving as an inflow hole passing through the upper wall up and down is formed. On a bottom wall of each pressure chamber 54 in the negative pressure chamber forming member 33, a second inflow hole 66 serving as an inflow hole passing through the bottom wall up and down is formed corresponding to each first inflow hole 65. That is, the first inflow hole 65 and the second inflow hole 66 have the same internal diameter and communicate with each other. Accordingly, each pressure chamber 54 and each ink supply chamber 64 communicate with each other through each first inflow hole 65 and each second inflow hole 66.

As shown in FIG. 4, in the pressure chamber 54 and the ink supply chamber 64, a pressure valve body 67 serving as an inflow hole valve body is accommodated to be stretched between both the chambers 54 and 64. The pressure valve body 67 includes a cylindrical pressure valve shaft 68 inserted between the first inflow hole 65 and the second inflow hole 66 and a disc-shaped flange 69 which is provided in a lower end portion of the pressure valve shaft 68 in the ink supply chamber 64 and has a larger external diameter than the pressure valve shaft 68. A lower end of the pressure valve shaft 68 is connected with the center of an upper surface of the pressure flange 69, and an upper end of the pressure valve shaft 68 is in contact with a bottom surface of the pressure operating portion 49.

The external diameter of the pressure flange 69 is larger than the internal diameters of the first and second inflow holes 65 and 66 and is smaller than the internal diameter of the ink supply chamber 64. On the upper surface of the pressure flange 69, an annular pressure sealing member 70 formed of a flexible material is fixed along a peripheral edge of the upper surface such that the pressure valve shaft 68 is surrounded. The external diameter of the pressure sealing member 70 is almost the same as the external diameter of the pressure flange 69. In addition, a pressure coiled spring 71 serving as an inflow hole valve body biasing member is interposed between a bottom surface of the pressure flange 69 and the upper surface of the partition wall 31 within the ink supply chamber 64.

The pressure coiled spring 71 biases the pressure valve body 67 upward such that the pressure valve body 67 is always in a closed state. Furthermore, in a state where the pressure valve body 67 is closed, the pressure sealing member 70 comes in contact with an upper wall surface of the ink supply chamber 64 in a state surrounding the first inflow hole 65 to thereby make the first inflow hole 65 closed. That is, the ink supply chamber 64 and the negative pressure chamber 54 do not communicate with each other.

In the negative pressure chamber forming member 33, a first discharge hole 72 serving as a discharge hole passing through a bottom wall in a front end portion of each pressure chamber 54 up and down is formed on the bottom wall. In addition, a second discharge hole 73 serving as a discharge hole passing through the decompression chamber forming member 32 up and down is formed in the decompression chamber forming member 32 so as to correspond to each first discharge hole 72. In addition, a third discharge hole 74 serving as a discharge hole passing through the partition wall 31 up and down is formed in the partition wall 31 so as to correspond to each second discharge hole 73.

Accordingly, each first discharge hole 72 and each second discharge hole 73 communicate with each other, and each second discharge hole 73 and each third discharge hole 74 communicate with each other. In addition, each third discharge hole 74 communicates with each defoaming chamber 39 through a flow channel (not shown) formed in the defoaming chamber forming member 30. Therefore, ink in each pressure chamber 54 is supplied to each defoaming chamber 39 through each first discharge hole 72, each second discharge hole 73, each third discharge hole 74, and a flow channel (not shown) formed in the defoaming chamber forming member 30.

In addition, when the amount of ink in each pressure chamber 54 decreases as the ink is ejected from the recording head 18, the negative pressure occurs in each pressure chamber 54. Then, the film member 52 is displaced to bend toward the pressure chamber 54 (downward) due to a difference between the negative pressure and the atmospheric pressure. By displacement of the film member 52, each pressure operating portion 49 elastically deforms to cause a rear end of each pressure operating portion 49 to bend downward as a hinge.

Due to the elastic deformation of each pressure operating portion 49, each pressure valve shaft 68 is pressed downward against the biasing force of each pressure coiled spring 71 by each pressure operating portion 49 and each pressure sealing member 70 is spaced apart from the upper wall surface of each ink supply chamber 64. As a result, each pressure valve body 67 is opened. In addition, when each pressure valve body 67 is in an open state, each first inflow hole 65 is in an open state, that is, each ink supply chamber 64 and each pressure chamber 54 communicate with each other.

Furthermore, in the present embodiment, each ink supply tube 24, each ink supply chamber 64, each first inflow hole 65, each second inflow hole 66, each pressure chamber 54, each first discharge hole 72, each second discharge hole 73, each third discharge hole 74, each defoaming chamber 39, and each outlet 40 form the liquid supply path. The liquid supply device is formed by each ink supply tube 24 and the valve unit 19.

Next, an operation of the valve unit 19 will be described.

When the negative pressure chamber 50 is decompressed until the pressure within the negative pressure chamber 53 reaches about −50 kPa by driving the decompression pump 62, the film member 52 is displaced to bend toward the negative pressure chamber 53 (downward) due to the atmospheric pressure. By displacement of the film member 52, the negative pressure operating portion 51 elastically deforms to cause the rear end of the negative pressure operating portion 51 to bend downward as a hinge. Due to the elastic deformation of the negative pressure operating portion 51, the negative pressure valve shaft 58 is pressed downward against the biasing force of the negative pressure coiled spring 61 by the negative pressure operating portion 51 and the negative pressure sealing member 60 is spaced apart from the upper wall surface within the case portion 43. As a result, the negative pressure valve body 57 is opened.

Then, the decompression chamber 42 is also decompressed up to the pressure of about −50 kPa together with the negative pressure chamber 53 by the decompression pump 62. When the decompression pump 62 is stopped and the negative pressure chamber 53 is opened to the atmosphere in this state, the pressure of the negative pressure chamber 53 and the pressure of the decompression chamber 42 increase. Then, the pressure of the negative pressure chamber 53 and the pressure of the decompression chamber 42 become −30 kPa, the negative pressure valve body 57 is closed by the biasing force of the negative pressure coiled spring 61. Then, the pressure of the negative pressure chamber 53 increases up to the atmospheric pressure, and the pressure of the decompression chamber 42 is maintained at −30 kPa.

Subsequently, when the amount of ink in each pressure chamber 54 decreases as the ink is ejected from the recording head 18 at the time of printing, the negative pressure occurs in each pressure chamber 54. Accordingly, the film member 52 is displaced to bend toward the pressure chamber 54 (downward) due to a difference between the negative pressure and the atmospheric pressure. By displacement of the film member 52, each pressure operating portion 49 elastically deforms to cause the rear end of each pressure operating portion 49 to bend downward as a hinge.

Due to the elastic deformation of each pressure operating portion 49, each pressure valve shaft 68 is pressed downward against the biasing force of each pressure coiled spring 71 by each pressure operating portion 49 and each pressure sealing member 70 is spaced apart from the upper wall surface of each ink supply chamber 64. As a result, each pressure valve body 67 is opened. Then, the ink in each ink supply chamber 64 flows into each pressure chamber 54 through the first inflow hole 65 and the second inflow hole 66. Then, when ink is sufficiently filled in each pressure chamber 54, the negative pressure within each pressure chamber 54 is removed and the film member 52 and each pressure operating portion 49 return to the original positions and each pressure valve body 67 is closed by the biasing force of each pressure coiled spring 71. Thus, each pressure chamber 54 is always maintained at fixed pressure.

In this case, the ink flowing through each first discharge hole 72, each second discharge hole 73, and each third discharge hole 74 from each pressure chamber 54 flows from each outlet 40 to the recording head 18 through each defoaming chamber 39. In addition, since the pressure of the decompression chamber 42 is maintained at −30 kPa, a bubble floating in ink within each defoaming chamber 39 permeates through the partition wall 31 to escape into the decompression chamber 42.

According to the present embodiment described above, the following effects can be obtained.

(1) When the negative pressure chamber 53 is decompressed by the decompression pump 62 until the pressure of the negative pressure chamber 53 becomes lower than the pressure value (−30 kPa) of the decompression chamber 42 set beforehand, the pressure within the decompression chamber 42 can be maintained at the pressure value (−30 kPa) of the decompression chamber 42 set beforehand even if the decompression pump 62 is stopped after the decompression. That is, in order to set the pressure of the decompression chamber 42 to −30 kPa, by decompressing the negative pressure chamber 53 up to −50 kPa lower than −30 kPa with the decompression pump 62 and then stopping the decompression pump 62 to make the negative pressure chamber 53 opened to the atmosphere, the negative pressure valve body 57 can be automatically closed at a point of time when the pressure of the decompression chamber 42 becomes −30 kPa. Accordingly, even if the decompression pump 62 is not continuously driven, the pressure of the decompression chamber 42 can be maintained at a desired pressure value (−30 kPa).

In addition, in order to make the negative pressure valve body 57 mechanically opened and closed from the outside, a hole and the like used to attach the mechanism should be provided in the valve unit 19. This causes a problem that moisture contained in ink evaporates from such a hole. In addition, there is a problem that the liquid supply device becomes large by providing such a mechanism in the valve unit 19. In this case, since the negative pressure valve body 57 is opened and closed only by decompression of the negative pressure chamber 53 using the decompression pump 62 in the present embodiment, such a problem does not occur.

(2) Each pressure chamber 54 and the negative pressure chamber 53 with negative pressure so that the decompression chamber 42 can be decompressed are formed by the same negative pressure chamber forming member 33 and film member 52. That is, the negative pressure chamber 53 is provided in parallel with each pressure chamber 54 that forms a part of the liquid supply path and the upper end opening of the negative pressure recess 44 and the upper end opening of each pressure recess 45 are sealed with the same one film member 52. Therefore, compared with a case where the upper end opening of the negative pressure recess 44 and the upper end opening of each pressure recess 45 are sealed with separate film members, it is possible to reduce the number of components included in the valve unit 19 and to make the liquid supply device small.

(3) Each pressure operating portion 49 and the negative pressure operating portion 51 constitute the operation plate 46 formed of the same one thin plate. That is, each pressure operating portion 49 and the negative pressure operating portion 51 are integrally formed. Therefore, the number of components included in the valve unit 19 can be reduced compared with a case where each pressure operating portion 49 and the negative pressure operating portion 51 are formed by separate members.

(4) The inner bottom surface of the defoaming chamber forming member 30 and the bottom surface of the partition wall 31 are bonded to each other with an adhesive, the upper surface of the partition wall 31 and the bottom surface of the decompression chamber forming member 32 are bonded to each other with an adhesive, and the upper surface of the decompression chamber forming member 32 and the bottom surface of the negative pressure chamber forming member 33 are bonded to each other with an adhesive. Accordingly, since the partition wall 31, the decompression chamber forming member 32, and the negative pressure chamber forming member 33 do not serve to make the negative pressure valve body 57 mechanically opened and closed from the outside, the partition wall 31, the decompression chamber forming member 32, and the negative pressure chamber forming member 33 can be completely covered with the defoaming chamber forming member 30 and the cover member 34. For this reason, since an adhesive is not exposed to the outside, the adhesive is not influenced by the external environment. As a result, since deterioration of the adhesive can be suppressed, a decrease in adhesive strength of the adhesive can be suppressed. Moreover, since the adhesive is covered with the defoaming chamber forming member 30 and the cover member 34 not allowing ink (liquid) to permeate therethrough, evaporation of ink to the outside can be suppressed without being influenced by the ink permeability of an adhesive.

(5) Since the air communicating path 37 extends in a long and meandering shape, the air communicating path 37 can make the air chamber 36 communicate with the atmosphere and prevent the moisture from evaporating from the air chamber 36 to the atmosphere.

### Modifications

The above embodiment may be modified as follows.

The adhesive used to bond the partition wall 31, the decompression chamber forming member 32, and the negative pressure chamber forming member 33 may be exposed to the outside.

Each pressure operating portion 49 and the negative pressure operating portion 51 may be formed of separate members.

The upper end opening of the negative pressure recess 44 and the upper end opening of each pressure recess 45 may be sealed with separate film members.

The decompression chamber 42 may be provided separately for each of the six defoaming chambers 39. In this case, it can be suitably performed to make a bubble in ink escape from the ink by adjusting the pressure of each decompression chamber 42 such that the pressure of each decompression chamber 42 becomes lower as much as the decompression chamber 42 corresponding to the ink in which a bubble is easily generated.

The defoaming chamber 39 does not need to be provided below the decompression chamber 42 in the vertical direction. For example, the defoaming chamber 39 may be disposed above the decompression chamber 42 so as to be adjacent to the decompression chamber 42 with a partitioning portion interposed therebetween. Alternatively, the defoaming chamber 39 may also be disposed laterally with the decompression chamber 42 with the partitioning portion interposed therebetween. Also in this case, since the negative pressure within the decompression chamber 42 acts on the defoaming chamber 39 through the partitioning portion, the growth of bubbles in the defoaming chamber 39 can be suppressed.

Although the depressurizing pump for depressurizing the inside of the depressurization chamber 39 had been described in this embodiment, the invention is not limited to it. For example, the inside of the defoaming chamber may be pressurized by a pressurizing pump for pressurizing the inside of the depressurization chamber is lower than that of the defoaming chamber. Like this examples, any configuration can be possible if blockage of the downstream channel of the defoaming chamber pressurizes the ink in the upstream channel of the defoaming chamber.

Even though the liquid ejecting apparatus is embodied as the ink jet printer 11 in the above-described embodiment, the liquid ejecting apparatus may also be embodied as a liquid ejecting apparatus that ejects liquid (including a liquid-like body in which particles of a functional material are dispersed or mixed and a fluid-like body, such as gel) other than ink. In addition, in this specification, examples of the ‘liquid’ include a liquid-like body and a fluid-like body as well as an inorganic solvent, an organic solvent, a solution, a liquid-like resin, and a liquid-like metal (liquid in which metal is melted).

Even though the liquid ejecting apparatus is embodied as the ink jet printer 11 in the above-described embodiment, a liquid ejecting apparatus that ejects or discharges liquid other than ink may also be adopted. For example, various liquid ejecting apparatuses each having a liquid ejecting head that discharges a small amount of liquid droplets may also be used. In addition, the liquid droplets refer to a state of liquid discharged from the liquid ejecting apparatus and include ones tailing in the shape of particle, tear, or thread. Moreover, the liquid referred herein may be a material that can be ejected by the liquid ejecting apparatus. For example, a material that is in a liquid-phase state may be used. That is, a liquid-like body, sol, or gel water having high or low viscosity and a fluid-like material, such as an inorganic solvent, an organic solvent, a solution, a liquid-like resin, and a liquid-like metal (liquid in which metal is melted) may be used. In addition, not only liquid as one state of a material but also a material in which particles of a functional material formed of solids, such as pigment or metallic particles are dissolved, dispersed, or mixed may also be used. Moreover, representative examples of liquid may include the ink described in the above embodiment and liquid crystal. Here, examples of the ink may include not only typical aqueous ink and oily ink but also various liquid compositions, such as gel ink and hot melt ink. Specific examples of the liquid ejecting apparatus may include a liquid ejecting apparatus that ejects liquid containing a material used for manufacturing a liquid crystal display device, an EL (electroluminescent) display device, and a surface-emitting display device, such as an electrode material or a color material, in the form of dispersion or solution, a liquid ejecting apparatus that ejects a bioorganic material used for manufacturing a biochip, a liquid ejecting apparatus that ejects liquid as a sample used as a precision pipet, a textile printing apparatus, and a microdispenser. In addition, a liquid ejecting apparatus that ejects lubricating oil to precision instruments, such as a watch and a camera, by pinpoint, a liquid ejecting apparatus that ejects transparent resin liquid, such as ultraviolet curing resin, onto a substrate in order to form a fine hemispherical lens (optical lens) used in an optical communication device or the like, or a liquid ejecting apparatus that ejects acid etching liquid or alkali etching liquid in order to etch a substrate or the like, may also be adopted. In addition, the invention may be applied to any one of the light ejecting apparatuses described above.

What is claimed is:

1. A liquid supply device comprising:
a liquid supply path used to supply liquid from an upstream side, which is a liquid supply source side, toward a downstream side at which the liquid is consumed;
a defoaming chamber that is provided in the middle of the liquid supply path and holds a bubble contained in the liquid in order to make the bubble escape from the liquid;
a decompression chamber that is provided at a position adjacent to the defoaming chamber with a partition wall interposed therebetween and is decompressed by a pump to have lower pressure than the defoaming chamber, the partition wall being configured to allow gas to permeate therethrough by decompression of the decompression chamber and to regulate permeation of liquid;
a negative pressure chamber that communicates with the decompression chamber through a communication hole and has negative pressure to decompress the decompression chamber;
a communication hole valve body that makes the communication hole closed when the communication hole valve body is in a closed state and makes the communication hole open when the communication hole valve body is in an open state;
a communication hole valve body biasing member that biases the communication hole valve body in a direction in which the communication hole valve body is always in a closed state;
a flexible member for negative pressure chamber that forms a part of a wall surface of the negative pressure chamber and is displaced on the basis of a change in pressure within the negative pressure chamber; and
a communication hole valve body pressure member that is displaced by the displacement of the flexible member for negative pressure chamber to thereby press the communication hole valve body in a direction in which the communication hole valve body is in an open state against a biasing force of the communication hole valve body biasing member.

2. A liquid supply device comprising:
a liquid supply path used to supply liquid from an upstream side, which is a liquid supply source side, toward a downstream side at which the liquid is consumed;
a defoaming chamber that is provided in the middle of the liquid supply path and is able to make a bubble contained in the liquid escape from the liquid;
a decompression chamber that is provided at a position adjacent to the defoaming chamber with a partitioning portion interposed therebetween and is decompressed by a pump to have lower pressure than the defoaming chamber, the partitioning portion being configured to allow gas to permeate therethrough by decompression of the decompression chamber and to regulate permeation of liquid;
a negative pressure chamber that communicates with the decompression chamber through a communication hole and has negative pressure to decompress the decompression chamber;
a communication hole valve body that makes the communication hole closed when the communication hole valve body is in a closed state and makes the communication hole open when the communication hole valve body is in an open state;
a communication hole valve body biasing member that biases the communication hole valve body in a direction in which the communication hole valve body is in a closed state;
a flexible member for negative pressure chamber that forms a part of a wall surface of the negative pressure chamber and is displaced on the basis of a change in pressure within the negative pressure chamber; and
a communication hole valve body pressure member that is displaced by the displacement of the flexible member for negative pressure chamber to thereby press the communication hole valve body in a direction in which the communication hole valve body is in an open state against a biasing force of the communication hole valve body biasing member.

3. The liquid supply device according to claim 1, further comprising:
a pressure chamber that has an inflow hole for inflow of the liquid and a discharge hole for discharge of the liquid;
an inflow hole valve body that makes the inflow hole closed when the inflow hole valve body is in a closed state and makes the inflow hole open when the inflow hole valve body is in an open state;
an inflow hole valve body biasing member that biases the inflow hole valve body in a direction in which the inflow hole valve body is always in a closed state;
a flexible member for pressure chamber that forms a part of a wall surface of the pressure chamber and is displaced on the basis of a change in pressure within the pressure chamber; and
an inflow hole valve body pressure member that is displaced by the displacement of the flexible member for pressure chamber to thereby press the inflow hole valve body in a direction in which the inflow hole valve body is in an open state against a biasing force of the inflow hole valve body biasing member,
wherein the pressure chamber and the negative pressure chamber are provided in parallel, and the flexible member for negative pressure chamber and the flexible member for pressure chamber are integrally formed.

4. The liquid supply device according to claim 3,
wherein the communication hole valve body pressure member and the inflow hole valve body pressure member are integrally formed.

5. The liquid supply device according to claim 1,
wherein a negative chamber forming member that forms the negative chamber, a decompression chamber forming member that forms the decompression chamber, and a partition wall that forms a partitioning portion interposed between the defoaming chamber and the decompression chamber are bonded to each other by adhesives in a state where the negative chamber forming member, the decompression chamber forming member, and the partition wall are piled, and
the adhesives are covered not to be exposed to the outside.

6. A liquid ejecting apparatus comprising:
a liquid ejecting head that ejects liquid; and
the liquid supply device according to claim 1 that supplies the liquid to the liquid ejecting head.
